(19) United States
(12) Patent Application Publication
(10) Pub. No.: US 2009/0147689 A1
(43) Pub. Date: Jun. 11, 2009

(54) Method, network apparatus and computer readable medium thereof for detecting the defect of the network

(75) Inventors: Hsin-Chien Kao, Pingtung City (TW); Jain Shing Wu, Taipei City (TW); Chih-Hung Lin, Jhonghe City (TW)

Correspondence Address: Joe McKinney Muncy, PO Box 1364, Fairfax, VA, 22038-1364, US

(73) Assignee: Institute for Information Industry

(21) Appl. No.: 12/010,841

(22) Filed: Jan. 30, 2008

(30) Foreign Application Priority Data
Dec. 11, 2007 (TW) 96147273

(51) Int. Cl. H04L 12/26

(52) U.S. Cl. 370/243

(57) ABSTRACT

Method, network apparatus and computer readable medium thereof for detecting the defect of the network are provided. The network apparatus comprises a controlling module and a relaying module. The controlling module comprises a generating module for generating a plurality of sub-detecting packets; and a first combining module for combining the plurality of sub-detecting module into a detecting packet; the relaying module is for receiving the detecting packet from the controlling module, the relaying module comprises a decomposing module for decomposing the detecting packet into the plurality of sub-detecting packets and transfer the sub-detecting packets to a target host; and a second combining module for receiving a plurality sub-result packets from the target host which are corresponding to the sub-detecting packets, combining the sub-result packets into a result packet and transferring the result packet to the controlling module to complete the detection.

### RELATED APPLICATIONS

This application claims priority to Taiwan Application Serial Number 96147273, filed Dec. 11, 2007, which is herein incorporated by reference.

### BACKGROUND

1. Field of Invention

The present invention relates to a method for detecting the defect of a network. More particularly, the present invention relates to a method, network apparatus and computer readable medium thereof for detecting the defect of a network.

2. Description of Related Art

Network security becomes an important issue due to the threats of various kinds of virus and hacker. Corporations spend lots of time and money to establish various security mechanisms to prevent the intrusion of virus and hackers. A well-established security mechanism can protect the information in the computer system of the corporations to keep the virus, spam mails and spywares away.

The detection of the defect of the network is an important aspect of the network security. After the detection, an adjustment corresponded to the defects can be made as soon as possible. The conventional detection method simulates the process of penetrations. A relay module is implanted in a host first, then a controlling module delivers different kinds of command packets to make the relay module generate various detection packets for attacking target hosts. Therefore, a large amount of packets are transferred between the controlling module and the relay module. Nevertheless, the intrusion detection system will easily detect the abnormal amount of packet transferring. Besides, the relay module can only be adapted to one kind of controlling module. If the controlling module is made to perform other kinds of detection process, the relay module will have to be replaced to match the controlling module.

Accordingly, what is needed is a method, network apparatus and computer readable medium thereof for detecting of the defect of the network that can decrease the amount of packets transferred between the control and the relay module, and a relay module that is not necessary to be replaced to match the controlling module to overcome the above issues. The present invention addresses such a need.

### SUMMARY

A method for detecting defects of network is provided. The method comprises the steps of: generating a plurality of sub-detecting packets; combining the plurality of sub-detecting packets to form a detecting packet; transferring the detecting packet to at least one relay module; decomposing the detecting packet into the plurality of sub-detecting packets; transferring the plurality of sub-detecting packets from the at least one relay module to a target host; transferring a plurality of sub-detection result packets from the target host to the at least one relay module; combining the plurality of sub-detection result packets to form a detection result packet; and transferring the detection result packet to a controlling module.

Another object of the present invention is to provide a method for detecting defects of network. The method comprises the steps of: generating a plurality of sub-detecting packets; combining the plurality of sub-detecting packets to form a detecting packet; transferring the detecting packet to at least one relay module; copying the detecting packet to form a plurality of detecting packets; decomposing the detecting packets respectively into the plurality of sub-detecting packets; transferring the plurality of sub-detecting packets from the at least one relay module to a plurality of target hosts corresponded to the plurality of sub-detecting packets; transferring a plurality of sub-detection result packets from the plurality of target hosts to the at least one relay module; combining the plurality of sub-detection result packets to form a detection result packet; and transferring the detection result packet to a controlling module.

Yet another object of the present invention is to provide a network apparatus. The network apparatus comprises: a controlling module and at least one relay module. The controlling module comprises a generating module for generating a plurality of sub-detecting packets; and a first combining module for combining the plurality of sub-detecting packets to form a detecting packet; The at least one relay module receives the detecting packet, wherein the at least one relay module comprises: a decomposing module for decomposing the detecting packets respectively into the plurality of sub-detecting packets and transferring the plurality of sub-detecting packets to a target host; and a second combining module for receiving a plurality of sub-detection result packets from the target host, combining the plurality of sub-detection result packets to form a detection result packet and transferring the detection result packet to the controlling module.

Yet another object of the present invention is to provide a network apparatus. The network apparatus comprises: a controlling module and at least one relay module. The controlling module comprises a generating module for generating a plurality of sub-detecting packets; and a first combining module for combining the plurality of sub-detecting packets to form a detecting packet; The at least one relay module receives the detecting packet, wherein the at least one relay module comprises: a copy module for copying the detecting packet to form a plurality of detecting packets; a decomposing module for decomposing the detecting packets respectively into the plurality of sub-detecting packets and transferring the plurality of sub-detecting packets to a target host; and a second combining module for receiving a plurality of sub-detection result packets from the target host, combining the plurality of sub-detection result packets to form a detection result packet and transferring the detection result packet to the controlling module.

Yet another object of the present invention is to provide a computer readable medium storing a computer program having a code for a network apparatus to execute a method for detecting defects of network, the method comprising the steps of: generating a plurality of sub-detecting packets; combining the plurality of sub-detecting packets to form a detecting packet; transferring the detecting packet to at least one relay module; decomposing the detecting packet into the plurality of sub-detecting packets; transferring the plurality of sub-detecting packets from the at least one relay module to a target host; transferring a plurality of sub-detection result packets from the target host to the at least one relay module; combining the plurality of sub-detection result packets to form a detection result packet; and transferring the detection result packet to a controlling module.

The present invention further comprises an object to provide a computer readable medium storing a computer program having a code for a network apparatus to execute a method for detecting defects of network, the method comprising the steps of: generating a plurality of sub-detecting packets; combining the plurality of sub-detecting packets to form a detecting packet; transferring the detecting packet to at least one relay module; copying the detecting packet to form a plurality of detecting packets; decomposing the detecting packets respectively into the plurality of sub-detecting packets; transferring the plurality of sub-detecting packets from the at least one relay module to a plurality of target hosts corresponded to the plurality of sub-detecting packets; transferring a plurality of sub-detection result packets from the plurality of target hosts to the at least one relay module; combining the plurality of sub-detection result packets to form a detection result packet; and transferring the detection result packet to a controlling module.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1A to FIG. 1C are the diagrams of a network apparatus and a target host of the first embodiment of the present invention;

FIG. 2 is a diagram of a network apparatus and a target host of the second embodiment of the present invention;

FIG. 3 and FIG. 4 are the flow charts of the third and fourth embodiment of the present invention;

FIG. 5 and FIG. 6 are the diagrams of a network apparatus and a target host of the fifth and sixth embodiment of the present invention; and

FIG. 7 and FIG. 8 are the flow charts of the seventh and eighth embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

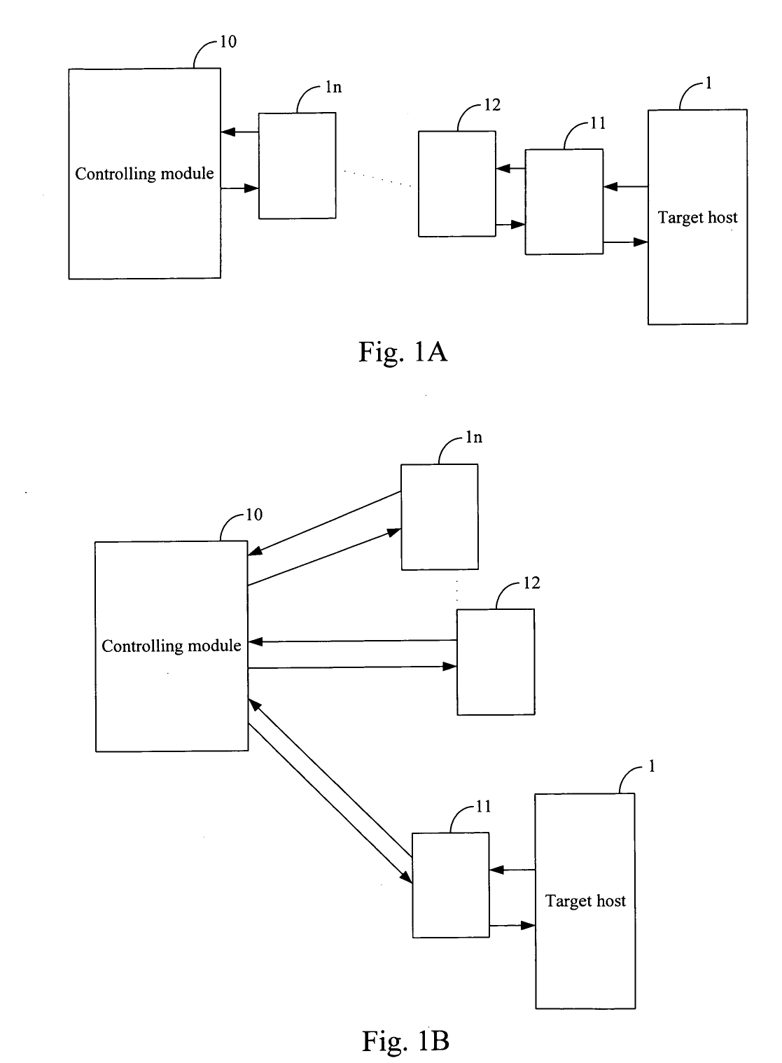

Please refer to FIG. 1A, a network apparatus and a target host 1 of the first embodiment of the present invention. The network apparatus detects the defects of the network and comprises a controlling module 10 and at least one relay module. In different embodiment, various number and connection type of the relay module can be made. As illustrated in FIG. 1A, the relay module 11, 12, . . . , 1n is seriesly connected. In FIG. 1B, another embodiment of the present invention, the relay module is parallelly connected. In other embodiment, the relay module can be connected in the combination of series and parallel connection. In order to make a clear description of the present invention, the following drawings omit the relay modules that are not substantially connected to the target host 1 and only depict the relay module 11 that is substantially connected to the target host 1. As depicted in FIG. 1c, a controlling module 10 and a relay module 11 are substantially placed in two host (not shown) respectively. The controlling module 10 transfers detecting packets to the target host 1 through the relay module 11 to detect the defects of the network of the target host 1.

The controlling module 10 comprises a generating module 100 for generating a plurality of sub-detecting packets 101, wherein the plurality of sub-detecting packets are network mapping packets, vulnerability scan packets, penetration test packets or the combination of the above. The type of the sub-detecting packets depends on the detection mode that the controlling module 10 performs. In different embodiment, different kinds of sub-detecting packets can be generated.

The controlling module 10 further comprises a first combining module 102. The combining module 102 combines the plurality of sub-detecting packets 101 to form a detecting packet 103. The relay module 1 1 receives the detecting packet 103. The relay module 11 comprises: a decomposing module 110 and a second combining module 112. The decomposing module 110 decomposes the detecting packets 103 respectively into the plurality of sub-detecting packets 101′ and transfers the plurality of sub-detecting packets 101′ to the target host 1. The second combining module 112 receives a plurality of sub-detection result packets 101′ from the target host 1, combines the plurality of sub-detection result packets 101′ to form a detection result packet 113 and transfers the detection result packet 113 to the controlling module 10.

The relay module 11 further comprises a verification module 114. The verification module 114 opens a port (not shown) and uses the port to receive a connecting packet 115 from the target host 1 to establish the connection between the relay module 11 and the target host 1.

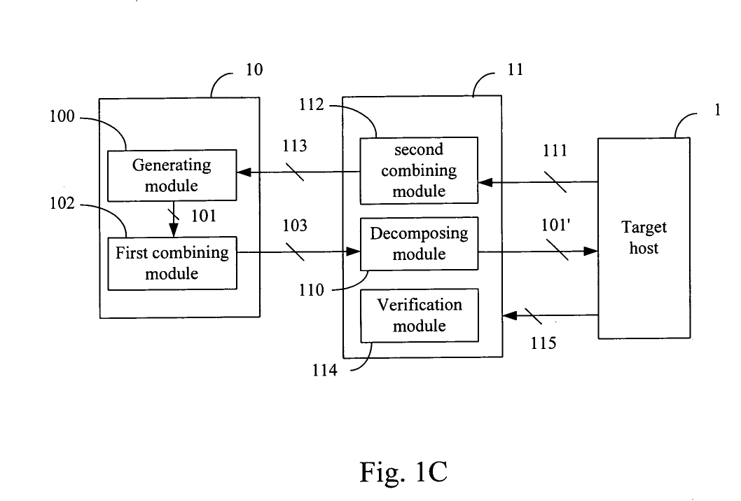

FIG. 2 illustrates the network apparatus and the target host 1 of the second embodiment of the present invention. The only different part of the network apparatus in the first and the second embodiment is the verification module. The verification module 114′ of the second embodiment establishes the connection between the relay module 11 and the target host 1 after the plurality of sub-detecting packets 101′ are transferred to the target host 1, the verification module 114′ further transfers a first connecting packet 115′ from the relay module 11 to the target host 1 and receives a second connecting packet 117 from the target host 1 to verify the connection.

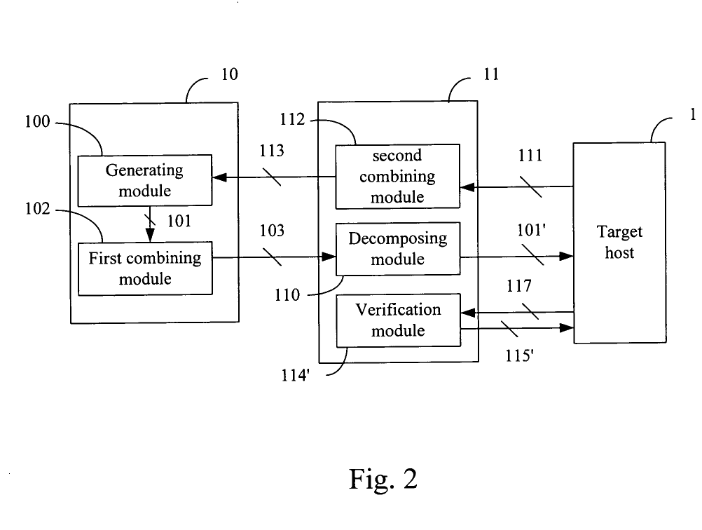

The third embodiment is a method for detecting the defects of the network. The method is applied to the network apparatus as described in the first embodiment. More specifically, the method for detecting the defects of the network in the third embodiment is implemented by using a computer program to control the modules in the network apparatus. The flow chart is shown in FIG. 3. The computer program can be stored in a computer readable medium such as an ROM, a flash memory, a floppy disc, a hard disc, an optical disc, a flash disc, a tape, a database accessible from a network, or a storage medium with the same functionality that can be easily thought by people skilled in this field.

In the first step 301, the generating module 100 of the controlling module 10 generates a plurality of sub-detecting packets 101; in step 302, the first combining module 102 combines the plurality of sub-detecting packets 101 to form a detecting packet 103; in step 303, the controlling module 100 transfers the detecting packet 103 to a relay module 11; in step 304, the decomposing module 110 of the relay module 11 decomposes the detecting packet 103 into the plurality of sub-detecting packets 101′; in step 305, the verification module 114 opens a port on the relay module 11; in step 306, the relay module 11 transfers the plurality of sub-detecting packets 101′ from the relay module 11 to a target host 1; in step 307, the verification module 114 establishes the connection between the relay module 11 and the target host 1 through a connecting packet 115 from the target host 1; in step 308, the second combining module 112 of the relay module 11 receives a plurality of sub-detection result packets 111 from the target host 1 and combines the plurality of sub-detection result packets 111 to form a detection result packet 113; and in step 309, transferring the detection result packet 113 to the controlling module 10.

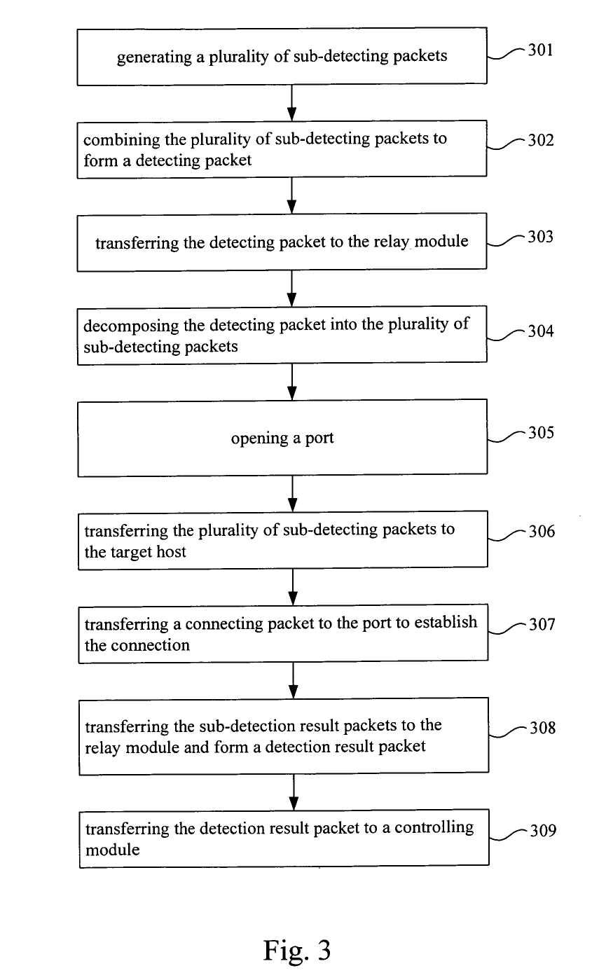

The fourth embodiment is a method for detecting the defects of the network. The method is applied to the network apparatus as described in the second embodiment. More specifically, the method for detecting the defects of the network in the fourth embodiment is implemented by using a computer program to control the modules in the network apparatus. The flow chart is shown in FIG. 4. The computer program can be stored in a computer readable medium such as an ROM, a flash memory, a floppy disc, a hard disc, an optical disc, a flash disc, a tape, a database accessible from a network, or a storage medium with the same functionality that can be easily thought by people skilled in this field.

In the first step 401, the generating module 100 of the controlling module 10 generates a plurality of sub-detecting packets 101; in step 402, the first combining module 102 combines the plurality of sub-detecting packets 101 to form a detecting packet 103; in step 303, the controlling module 100 transfers the detecting packet 103 to a relay module 11; in step 404, the decomposing module 110 of the relay module 11 decomposes the detecting packet 103 into the plurality of sub-detecting packets 101′; in step 405, the relay module 11 transfers the plurality of sub-detecting packets 101′ from the relay module 11 to a target host 1; in step 406, the verification module 114′ establishes the connection between the relay module 11 and the target host 1 after the plurality of sub-detecting packets 101′ open a port on the target host 1; in step 407, the verification module 114′ transfers a first connecting packet 115′ from the relay module 11 to the target host 1; in step 408, the verification module 114′ receives a second connecting packet 117 from the target host 1 to verify the connection; in step 409, the second combining module 112 receives a plurality of sub-detection result packets 111 from the target host 1 and combines the plurality of sub-detection result packets 111 to form a detection result packet 113; and in step 410, the relay module 11 transfers the detection result packet 113 to the controlling module 10.

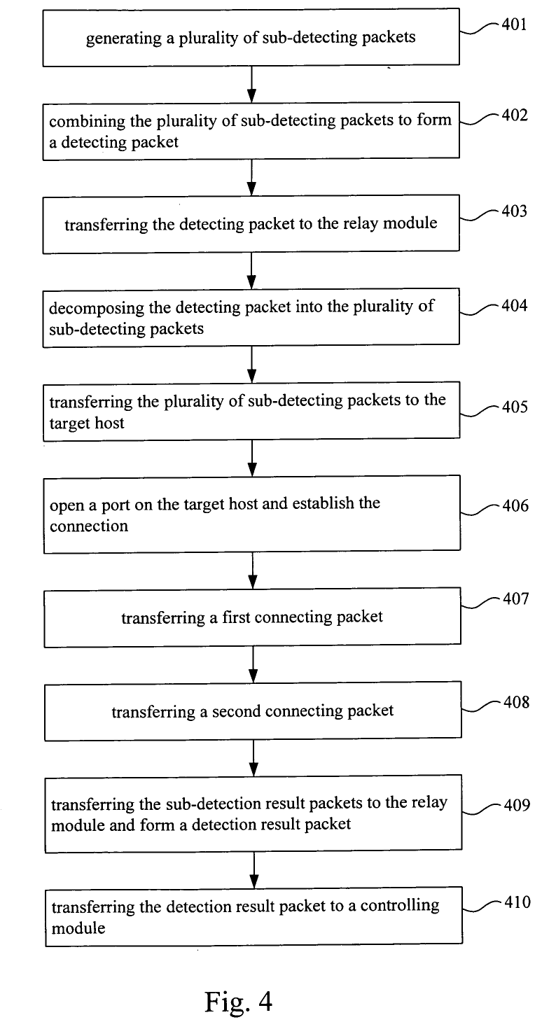

FIG. 5 illustrates the network apparatus and the plurality of the target hosts 5a, 5b, . . . , 5n of the fifth embodiment of the present invention. As described in the first embodiment, various number and connection type of the relay module can be made. The network apparatus detects the defects of the network and comprises a controlling module 50 and a relay module 51.

As depicted in FIG. 5, a controlling module 50 and a relay module 51 are substantially placed in two host (not shown) respectively. The controlling module 50 transfers detecting packets to the plurality of target hosts 5a, 5b, . . . , 5n through the relay module 51 to detect the defects of the network of the target host 5a, 5b, . . . , 5n.

The controlling module 50 comprises a generating module 500 for generating a plurality of sub-detecting packets 501, wherein the plurality of sub-detecting packets are network mapping packets, vulnerability scan packets, penetration test packets or the combination of the above. The type of the sub-detecting packets depends on the detection mode that the controlling module 50 performs. In different embodiment, different kinds of sub-detecting packets can be generated.

The controlling module 50 further comprises a first combining module 502. The combining module 502 combines the plurality of sub-detecting packets 501 to form a detecting packet 503. The relay module 51 receives the detecting packet 503. The relay module 51 comprises: a copying module 510, a decomposing module 512 and a second combining module 514. The copying module 510 copies the detecting packet 503 to form a plurality of detecting packets 503a, 503b, . . . , 503n. The decomposing module 512 decomposes the detecting packets 503a, 503b, . . . , 503n respectively into the plurality of sub-detecting packets 501a′, 5031b′, . . . , 501n′ and transfers the plurality of sub-detecting packets 501a′, 501b′, . . . , 501n′ to the target host 5a, 5b, . . . , 5n. The second combining module 514 receives a plurality of sub-detection result packets 501a′, 501b′, . . . , 501n′ from the target host 5a, 5b, . . . , 5n, combines the plurality of sub-detection result packets 511a, 511b, . . . , 511n to form a detection result packet 513 and transfers the detection result packet 513 to the controlling module 50.

The relay module 51 further comprises a verification module 516. The verification module 516 opens a port (not shown) and uses the port to receive a connecting packet 515a, 515b, . . . , 515n from the target host 5a, 5b, . . . , 5n to establish the connection between the relay module 51 and the target host 5a, 5b, . . . , 5n.

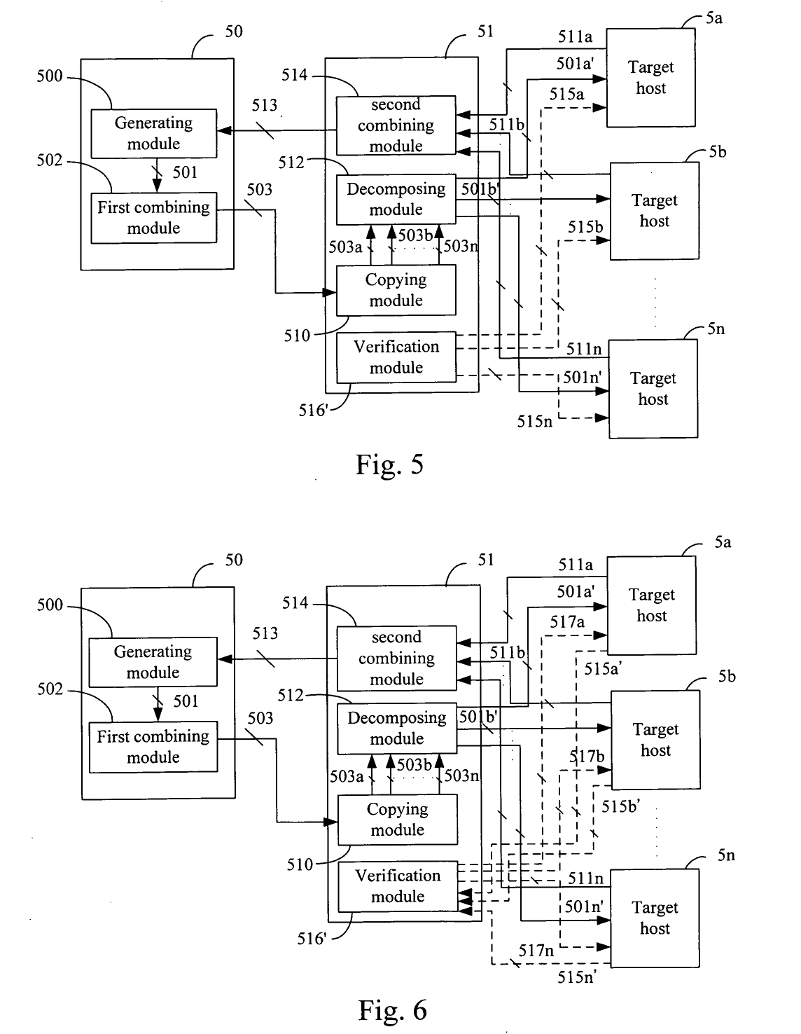

FIG. 6 illustrates the network apparatus and the target host 5a, 5b, . . . , 5n of the sixth embodiment of the present invention. The only different part of the network apparatus in the first and the second embodiment is the verification module. The verification module 516′ of the second embodiment establishes the connection between the relay module 51 and the target host 5a, 5b, . . . , 5n after the plurality of sub-detecting packets 501a′, 501b′, . . . , 501n′ are transferred to the target host 5a, 5b, . . . , 5n, the verification module 516′ further transfers a first connecting packet 515a′, 515b′, . . . , 515n′ from the relay module 51 to the target host 5a, 5b, . . . , 5n and receives a second connecting packet 517a, 517b, . . . , 517n from the target host 5a, 5b, . . . , 5n to verify the connection.

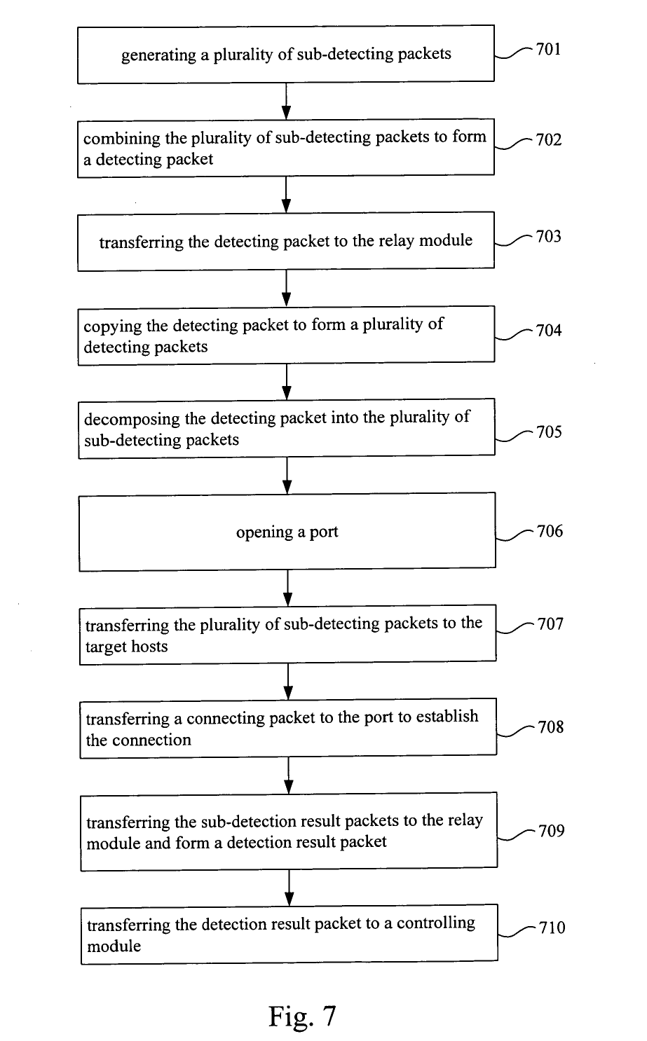

The seventh embodiment is a method for detecting the defects of the network. The method is applied to the network apparatus as described in the fifth embodiment. More specifically, the method for detecting the defects of the network in the seventh embodiment is implemented by using a computer program to control the modules in the network apparatus. The flow chart is shown in FIG. 7. The computer program can be stored in a computer readable medium such as an ROM, a flash memory, a floppy disc, a hard disc, an optical disc, a flash disc, a tape, a database accessible from a network, or a storage medium with the same functionality that can be easily thought by people skilled in this field.

In the first step 701, the generating module 500 of the controlling module 50 generates a plurality of sub-detecting packets 501; in step 702, the first combining module 502 combines the plurality of sub-detecting packets 501 to form a detecting packet 503; in step 703, the controlling module 500 transfers the detecting packet 503 to a relay module 51; in step 704, the copying module 510 copies the detecting packet 503 to form a plurality of detecting packets 503a, 503b, . . . , 503n; in step 705, the decomposing module 512 of the relay module 51 decomposes the detecting packet 503a, 503b, . . . , 503n into the plurality of sub-detecting packets 501a′, 501b′, . . . , 501n′; in step 706, the verification module 516 opens a port on the relay module 51; in step 707, the relay module 51 transfers the plurality of sub-detecting packets 501a′, 501b′, . . . , 501n′ from the relay module 51 to a target host 5a, 5b, . . . , 5n; in step 708, the verification module 516 establishes the connection between the relay module 51 and the target host 5a, 5b, . . . , 5n through a connecting packet 515a, 515b, . . . , 515n from the target host 5a, 5b, . . . , 5n; in step 709, the second combining module 514 of the relay module 51 receives a plurality of sub-detection result packets 511a, 511b, . . . , 511n from the target host 5a, 5b, . . . , 5n and combines the plurality of sub-detection result packets 511a, 511b, . . . , 511n to form a detection result packet 513; and in step 710, transferring the detection result packet 513 to the controlling module 50.

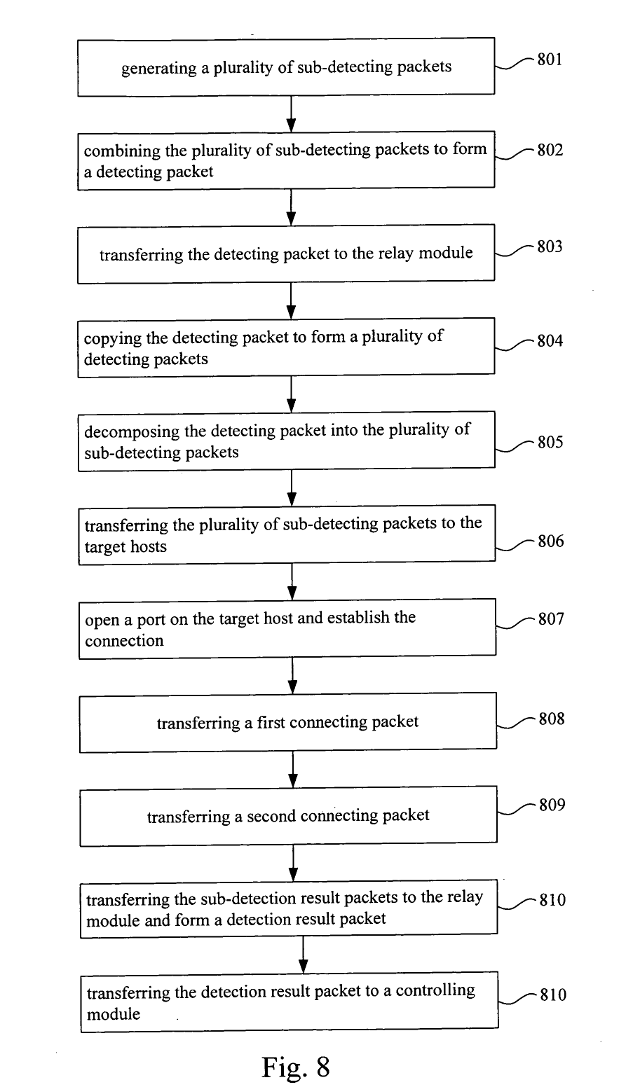

The eighth embodiment is a method for detecting the defects of the network. The method is applied to the network apparatus as described in the sixth embodiment. More specifically, the method for detecting the defects of the network in the eighth embodiment is implemented by using a computer program to control the modules in the network apparatus. The flow chart is shown in FIG. 8. The computer program can be stored in a computer readable medium such as an ROM, a flash memory, a floppy disc, a hard disc, an optical disc, a flash disc, a tape, a database accessible from a network, or a storage medium with the same functionality that can be easily thought by people skilled in this field.

In the first step 801, the generating module 500 of the controlling module 50 generates a plurality of sub-detecting packets 501; in step 802, the first combining module 502 combines the plurality of sub-detecting packets 501 to form a detecting packet 503; in step 803, the controlling module 500 transfers the detecting packet 503 to a relay module 51; in step 804, the copying module 510 copies the detecting packet 503 to form a plurality of detecting packets 503a, 503b, . . . , 503n; in step 805, the decomposing module 512 of the relay module 51 decomposes the detecting packet 503a, 503b, . . . , 503n into the plurality of sub-detecting packets 501a′, 501b′, . . . , 501n′; in step 806, the verification module 516′ establishes the connection between the relay module 51 and the target host 5a, 5b, . . . , 5n after the plurality of sub-detecting packets 501a′, 501b′, . . . , 501n′ open a port on the target host 5a, 5b, . . . , 5n; in step 807, the verification module 516′ transferring a first connecting packet 515a′, 515b′, . . . , 515n′ from the relay module 51 to the target host 5a, 5b, . . . , 5n; in step 808, the verification module 516′ receives a second connecting packet 517a, 517b, . . . , 517n from the target host to the relay module 51 to verify the connection; in step 809, the second combining module 514 of the relay module 51 receives a plurality of sub-detection result packets 511a, 511b, . . . , 511n from the target host 5a, 5b, . . . , 5n and combines the plurality of sub-detection result packets 511a, 511b, . . . , 511n to form a detection result packet 513; and in step 810, transferring the detection result packet 513 to the controlling module 50.

The above embodiments show that, the amount of the transferring packets can be reduced by combining the plurality of sub-detecting packets to form a detecting packet. Further, the relay module in the present invention only transfers the packets. Therefore, the relay module is not necessary to be replaced to match the different operations of the controlling module.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for detecting defects of network comprising the steps of:
generating a plurality of sub-detecting packets;
combining the plurality of sub-detecting packets to form a detecting packet;
transferring the detecting packet to at least one relay module;
decomposing the detecting packet into the plurality of sub-detecting packets;
transferring the plurality of sub-detecting packets from the at least one relay module to a target host;
transferring a plurality of sub-detection result packets from the target host to the at least one relay module;
combining the plurality of sub-detection result packets to form a detection result packet; and
transferring the detection result packet to a controlling module.

2. The method of claim 1, wherein the at least one relay module is seriesly connected, and the detection packet is transferred through the at least one relay module.

3. The method of claim 1, wherein the at least one relay module is parallelly connected, and the detection packet is copied to form at least one detection packet and transferred to the at least one module respectively.

4. The method of claim 1, wherein the plurality of sub-detecting packets are for establishing a connection between the at least one relay module and the target host.

5. The method of claim 4, further comprising steps of:
opening a port on the at least one relay module;
transferring the plurality of sub-detecting packets to the target host; and
transferring a connecting packet from the target host to the port of the at least one relay module to establish the connection between the at least one relay module and the target host.

6. The method of claim 4, further comprising steps of:
transferring the plurality of sub-detecting packets to the target host to open a port on the target host and establish the connection between the at least one relay module and the target host;
transferring a first connecting packet from the at least one relay module to the target host; and
transferring a second connecting packet from the target host to the at least one relay module to verify the connection.

7. A method for detecting defects of network comprising the steps of:
generating a plurality of sub-detecting packets;
combining the plurality of sub-detecting packets to form a detecting packet;
transferring the detecting packet to at least one relay module;
copying the detecting packet to form a plurality of detecting packets;
decomposing the detecting packets respectively into the plurality of sub-detecting packets;
transferring the plurality of sub-detecting packets from the at least one relay module to a plurality of target hosts corresponded to the plurality of sub-detecting packets;
transferring a plurality of sub-detection result packets from the plurality of target hosts to the at least one relay module;
combining the plurality of sub-detection result packets to form a detection result packet; and
transferring the detection result packet to a controlling module.

8. The method of claim 7, wherein the at least one relay module is seriesly connected, and the detection packet is transferred through the at least one relay module.

9. The method of claim 7, wherein the at least one relay module is parallelly connected, and the detection packet is copied to form at least one detection packet and transferred to the at least one module respectively.

10. The method of claim 7, wherein the plurality of sub-detecting packets are for establishing a connection between the at least one relay module and the target host.

11. The method of claim 10, further comprising steps of:
opening a port on the at least one relay module;
transferring the plurality of sub-detecting packets to the target host; and
transferring a connecting packet from the target host to the port of the at least one relay module to establish the connection between the at least one relay module and the target host.

12. The method of claim 10, further comprising steps of:
transferring the plurality of sub-detecting packets to the target host to open a port on the target host and establish the connection between the at least one relay module and the target host;
transferring a first connecting packet from the at least one relay module to the target host; and
transferring a second connecting packet from the target host to the at least one relay module to verify the connection.

13. A network apparatus comprising:
a controlling module comprising:
a generating module for generating a plurality of sub-detecting packets; and
a first combining module for combining the plurality of sub-detecting packets to form a detecting packet;
at least one relay module for receiving the detecting packet, wherein the at least one relay module comprises:
a decomposing module for decomposing the detecting packets respectively into the plurality of sub-detecting packets and transferring the plurality of sub-detecting packets to a target host; and
a second combining module for receiving a plurality of sub-detection result packets from the target host, combining the plurality of sub-detection result packets to form a detection result packet and transferring the detection result packet to the controlling module.

14. The network apparatus of claim 13, wherein the at least one relay module is seriesly connected, and the detection packet is transferred through the at least one relay module.

15. The network apparatus of claim 13, wherein the at least one relay module is parallelly connected, and the detection packet is copied to form at least one detection packet and transferred to the at least one module respectively.

16. The network apparatus of claim 13, wherein the plurality of sub-detecting packets are for establishing a connection between the at least one relay module and the target host.

17. The network apparatus of claim 16, the at least one replay module further comprises a verification module for opening a port on the at least one relay module and using the port to receive a connecting packet from the target host to establish the connection between the at least one relay module and the target host.

18. The network apparatus of claim 16, the at least one replay module further comprises a verification module for establishing the connection between the at least one relay module and the target host after the plurality of sub-detecting packets are transferred to the target host, the verification module further transfers a first connecting packet from the at least one relay module to the target host and receives a second connecting packet from the target host to verify the connection.

19. The network apparatus of claim 13, the plurality of sub-detecting packets are network mapping packets, vulnerability scan packets, penetration test packets or the combination of the above.

20. A network apparatus comprising:
a controlling module comprising:
a generating module for generating a plurality of sub-detecting packets; and
a first combining module for combining the plurality of sub-detecting packets to form a detecting packet;
at least one relay module for receiving the detecting packet, wherein the at least one relay module comprises:
a copy module for copying the detecting packet to form a plurality of detecting packets;
a decomposing module for decomposing the detecting packets respectively into the plurality of sub-detecting packets and transferring the plurality of sub-detecting packets to a target host; and
a second combining module for receiving a plurality of sub-detection result packets from the target host, combining the plurality of sub-detection result packets to form a detection result packet and transferring the detection result packet to the controlling module.

21. The network apparatus of claim 20, wherein the at least one relay module is seriesly connected, and the detection packet is transferred through the at least one relay module.

22. The network apparatus of claim 20, wherein the at least one relay module is parallelly connected, and the detection packet is copied to form at least one detection packet and transferred to the at least one module respectively.

23. The network apparatus of claim 20, wherein the plurality of sub-detecting packets are for establishing a connection between the at least one relay module and the target host.

24. The network apparatus of claim 23, the at least one replay module further comprises a verification module for opening a port on the at least one relay module and using the port to receive a connecting packet from the target host to establish the connection between the at least one relay module and the target host.

25. The network apparatus of claim 23, the at least one replay module further comprises a verification module for establishing the connection between the at least one relay module and the target host after the plurality of sub-detecting packets are transferred to the target host, the verification module further transfers a first connecting packet from the at least one relay module to the target host and receives a second connecting packet from the target host to verify the connection.

26. The network apparatus of claim 20, the plurality of sub-detecting packets are network mapping packets, vulnerability scan packets, penetration test packets or the combination of the above.

27. A computer readable medium storing a computer program having code for a network apparatus to execute a method for detecting defects of network, the method comprising the steps of:
generating a plurality of sub-detecting packets;
combining the plurality of sub-detecting packets to form a detecting packet;
transferring the detecting packet to at least one relay module;
decomposing the detecting packet into the plurality of sub-detecting packets;
transferring the plurality of sub-detecting packets from the at least one relay module to a target host;
transferring a plurality of sub-detection result packets from the target host to the at least one relay module;
combining the plurality of sub-detection result packets to form a detection result packet; and
transferring the detection result packet to a controlling module.

28. The computer readable medium of claim 27, wherein the at least one relay module is seriesly connected, and the detection packet is transferred through the at least one relay module.

29. The computer readable medium of claim 26, wherein the at least one relay module is parallelly connected, and the detection packet is copied to form at least one detection packet and transferred to the at least one module respectively.

30. The computer readable medium of claim 26, wherein the plurality of sub-detecting packets are for establishing a connection between the at least one relay module and the target host.

31. The computer readable medium of claim 30, further comprising steps of:
opening a port on the at least one relay module;
transferring the plurality of sub-detecting packets to the target host; and
transferring a connecting packet from the target host to the port of the at least one relay module to establish the connection between the at least one relay module and the target host.

32. The computer readable medium of claim 30, further comprising steps of:
transferring the plurality of sub-detecting packets to the target host to open a port on the target host and establish the connection between the at least one relay module and the target host;
transferring a first connecting packet from the at least one relay module to the target host; and
transferring a second connecting packet from the target host to the at least one relay module to verify the connection.

33. The computer readable medium of claim 27, the plurality of sub-detecting packets are network mapping packets, vulnerability scan packets, penetration test packets or the combination of the above.

34. A computer readable medium for detecting defects of network comprising the steps of:
generating a plurality of sub-detecting packets;
combining the plurality of sub-detecting packets to form a detecting packet;
transferring the detecting packet to at least one relay module;
copying the detecting packet to form a plurality of detecting packets;
decomposing the detecting packets respectively into the plurality of sub-detecting packets;
transferring the plurality of sub-detecting packets from the at least one relay module to a plurality of target hosts corresponded to the plurality of sub-detecting packets;
transferring a plurality of sub-detection result packets from the plurality of target hosts to the at least one relay module;
combining the plurality of sub-detection result packets to form a detection result packet; and
transferring the detection result packet to a controlling module.

35. The computer readable medium of claim 34, wherein the at least one relay module is seriesly connected, and the detection packet is transferred through the at least one relay module.

36. The computer readable medium of claim 34, wherein the at least one relay module is parallelly connected, and the detection packet is copied to form at least one detection packet and transferred to the at least one module respectively.

37. The computer readable medium of claim 34, wherein the plurality of sub-detecting packets are for establishing a connection between the at least one relay module and the target host.

38. The computer readable medium of claim 37, further comprising steps of:
opening a port on the at least one relay module;
transferring the plurality of sub-detecting packets to the target host; and
transferring a connecting packet from the target host to the port of the at least one relay module to establish the connection between the at least one relay module and the target host.

39. The computer readable medium of claim 37, further comprising steps of:
transferring the plurality of sub-detecting packets to the target host to open a port on the target host and establish the connection between the at least one relay module and the target host;
transferring a first connecting packet from the at least one relay module to the target host; and
transferring a second connecting packet from the target host to the at least one relay module to verify the connection.

40. The computer readable medium of claim 34, the plurality of sub-detecting packets are network mapping packets, vulnerability scan packets, penetration test packets or the combination of the above.
